(19) United States
(12) Patent Application Publication
(10) Pub. No.: US 2007/0217368 A1
(43) Pub. Date: Sep. 20, 2007

(54) Radio communication system, radio base station, radio communication terminal, radio communication method, and program for radio communication system

(76) Inventor: Hideki Kurokawa, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 11/724,336

(22) Filed: Mar. 15, 2007

(30) Foreign Application Priority Data
Mar. 16, 2006 (JP) 073302/2006

(51) Int. Cl. H04B 7/216

(52) U.S. Cl. 370/335

(57) ABSTRACT

When it is possible to connect a radio communication terminal only at substantially the same frequency as is used in radio communication in a radio base station, and using a slot overlapping the slot used in the radio base station, the radio base station transmits a signal including power control notification for notifying the radio communication terminal to lower transmission power from the radio communication terminal to a predetermined power, with which communication is still maintained, to the radio communication terminal at the transmission power lowered to the predetermined power, causes the radio communication terminal to make connection at transmission power at a controlled power value, and starts packet transmission.

### BACKGROUND OF THE INVENTION

1. Field of the Invention

The present invention relates to a radio communication system including a plurality of radio base stations, a radio base station, a radio communication terminal, a radio communication method, and a program for the radio communication system.

2. Description of Related Art

In general, when a radio section use half-duplex communication such as defined in the IEEE802.11 standard, the radio base station needs to once check whether a medium (a communication tolerance in a communication band) is busy, i.e., whether frame transmission at a communication frequency is possible before each of radio base stations transmits a frame.

In such a radio communication system, when the radio base station detects a transmission frame from another radio base station in the medium, the radio base station trying the transmission temporarily stops transmission processing and resumes the transmission processing after a predetermined waiting time passes.

For the Medium Access Control (MAC) in the IEEE802.11 wireless LAN, the Polling Coordination Function (PCF) and the Distributed Coordination Function (DCF) are prescribed as radio channel access methods.

In the PCF scheme, a radio base station sequentially allocates a transmission right to respective radio communication terminals. Since accesses to a radio channel are centrally controlled in this way, collision of frames does not occur in a Contention Free Period (CFP) during which the PCF works.

On the other hand, in the DCF scheme, respective radio communication terminals acquire a transmission right for a radio channel in competition with each other. Since the respective radio communication terminals perform this transmission right acquisition competition, collision of frames occurs in a Contention Period (CP) during which the DCF works.

As such a conventional radio communication system, there is a radio communication system in which, when interference occurs between two access points because the access points use communication channels of the same frequency band, an access point arbitrator gives permission of communication to one of the access points and puts the other access points on standby (see, for example, Japanese Patent Application Laid Open No. 2004-48356 (document 1)).

There is a radio communication system that uses scheduling information included in a scheduling information parameter set to decide a time interval during which an access point functions as a point coordinator (see, for example, Japanese Patent Application Laid Open No. 2004-187297 (document 2)).

However, the waiting time in the conventional radio communication system increases exponentially according to the number of times the medium is found busy at a point of transmission. Thus, even when a transmission frame itself is short, time required for transmission of one frame increases because there is the waiting time, thereby causing deterioration in transmission frame efficiency.

When the time required for transmission of one frame increases in this way, in the case of data communication, transmission speed of data falls and, in the case of sound communication, the number of simultaneous calls is decreased.

In order to reduce the waiting time, if the number of radio base stations is increased or radio base stations are replaced with a high-performance model that allows a large number of simultaneous connections, the cost rises.

In recent years, since more and more radio base stations tend to be set, it is likely that radio base stations that share channels also increase.

When the radio base stations sharing channels are more installed, since a probability of collision of frame transmission timing also increases, the waiting time gets longer. Therefore, it is important to control the occurrence of collision of frame transmission timing and reduce the waiting time.

Documents 1 and 2 disclose that radio base stations or system control devices control communication, and aims to prevent mutual interference among access points.

As described above, although the CFP in which the radio communication system performs allocation control for a transmission right, and the CP in which the radio communication system does not perform the allocation control are defined, documents 1 and 2 do not take into account a period when the radio communication system does not perform sequential allocation of a transmission right to the respective radio communication terminals.

### SUMMARY OF THE INVENTION

In view of such a situation, it is an exemplary objective of the present embodiments to provide a radio communication system, a radio base station, a radio communication terminal, a radio communication method, and a program for the radio communication system that prevent, even in a period when control for allocating a transmission right from the radio communication system to respective radio communication terminals is not performed, occurrence of collision of frame transmission timing, increase a maximum number of simultaneous connections within a limited communication capacity range of a communication frequency, reduce waiting time, and speed communication up without causing an increase in cost for addition of radio base stations, replacement with a high-performance model, and the like.

A first aspect of the present embodiments is a radio communication system in which a plurality of radio base stations is connected to a system control device, and the radio base stations and radio communication terminals are capable of communicating with each other by radio. The radio communication system includes power adjusting means for lowering transmission power for performing radio communication between a first radio base station and a radio communication terminal to predetermined power, with which communication is still maintained, and lowering transmission power for performing radio communication between a second radio base station and a radio communication terminal to predetermined power, with which communication is still maintained, while the first radio base station and the second radio base station communicate at substantially a same frequency.

Communication ranges of the first and second radio base stations may overlap.

It is preferable that each of the radio base stations includes a radio transmission and reception section that performs transmission and reception by radio communication and, when the radio transmission and reception of a first radio base station receives, from a second radio base station, notification indicating that the second radio base station performs transmission at a frequency substantially equal to a frequency that the first radio base station intends to use or is using, the radio base station recognizes that the second radio base station performs transmission at substantially the same frequency.

It is preferable that the power adjusting means includes a base-station-side power adjusting section that adjusts transmission power of radio base stations and a terminal-side power adjusting section that adjusts transmission power of radio communication terminals.

It is preferable that each of the radio base stations includes a power-adjustment notifying section that requests a radio communication terminal to lower the transmission power to predetermined power and, when the power adjusting section lowers the transmission power to the predetermined power, the base-station-side power adjusting section of a radio base station lowers the transmission power to the predetermined power, the power-adjustment notifying section notifies a radio communication terminal of the predetermined power, and the terminal-side-power adjusting section of a radio communication terminal, which receives the notification, lowers the transmission power to the predetermined power notified by the power-adjustment notifying section.

The radio communication between radio base stations and radio communication terminal may be half duplex radio communication and, when overlap occurs in transmission timing, the power adjusting section may lower the transmission power to the predetermined power.

It is preferable that the radio communication between radio base stations and radio communication terminals is sectioned into units of transmission time and the overlap in the transmission timing indicates that the same unit of transmission time is used.

It is preferable that radio base stations support a plurality of transmission rates in the radio communication with radio communication terminals, and the transmission at substantially the same frequency indicates that the same transmission rates are selected from the transmission rates.

A radio base station according to a second aspect of the present embodiments is capable of communicating with a radio communication terminal by radio. The radio base station includes a base-station-side power adjusting section that lowers, when another radio base station performs transmission at substantially a same communication frequency, transmission power for performing radio communication with a radio communication terminal to predetermined power, with which communication is still maintained, and a power-adjustment notifying section that requests the radio communication terminal to lower transmission power to the predetermined power, with which communication is still maintained.

Communication ranges of the radio base station and another radio base station may overlap.

It is preferable that the radio base station includes a radio transmission and reception section that transmits and receives signals by radio communication and, when the radio transmission and reception section receives, from another radio base station, notification indicating that another radio base station performs transmission at a frequency substantially equal to a frequency that the radio base station intends to use or is using, the radio base station recognizes that another radio base station performs transmission at substantially the same frequency.

It is preferable that the radio communication between the radio base station and a radio communication terminal is half duplex radio communication and, when overlap occurs in transmission timing, the base-station-side power adjusting section lowers the transmission power to the predetermined power.

It is preferable that the radio communication between the radio base station and a radio communication terminal is sectioned into units of transmission time, and the overlap in the transmission timing indicates that the same unit of transmission time is used.

It is preferable that the radio base station supports a plurality of transmission rates in the radio communication with the radio communication terminals and the transmission at substantially the same frequency indicate that the same transmission rates are selected from the transmission rates.

A radio communication terminal according to a third aspect of the present embodiments includes a radio transmission and reception section that transmits and receives signals by radio communication, and a terminal-side-power adjusting section that lowers, when the radio transmission and reception section receives, from a radio base station, notification for lowering transmission power to predetermined power, with which communication is still maintained, the transmission power to the predetermined power.

A radio communication method according to a fourth aspect of the present embodiments is used for a radio communication system in which a plurality of radio base stations are connected, and the radio base stations and radio communication terminals are capable of communicating with each other by radio. The radio communication method includes a frequency receiving step of receiving communication frequency information on a first radio base station from the first radio base station, a collision judging step of judging whether a second radio base station and the first radio base station perform transmission at substantially a same frequency based on the frequency information, and a power adjusting step of lowering, when it is judged that substantially the same frequency is used, transmission power between the second radio base station and a radio communication terminal to predetermined power, with which communication between the second radio base station and the radio communication terminal is still maintained, and lowering transmission power between the first radio base station and a radio communication terminal to predetermined power, with which communication between the first radio base station and the radio communication terminal is still maintained.

It is preferable that communication ranges of the first and second base stations overlap.

It is preferable that, in the power adjusting step, transmission power of radio base stations and radio communication terminals is adjusted.

It is preferable that, in the power adjusting step, the radio base stations lower transmission power to the predetermined power and notify the radio communication terminal of the predetermined power, and the radio communication terminal, receiving the notification, lowers transmission power to the power notified.

It is preferable that radio communication between radio base stations and radio communication terminals is half duplex radio communication and, the method further includes a timing judging step of judging whether overlap of transmission timing occurs, and, when it is judged in the timing judging step that overlap occurs, adjustment in the power adjusting step is performed.

It is preferable that the radio communication between radio base stations and radio communication terminals is sectioned into units of transmission power, and the overlap of the transmission timing indicates that the same unit of transmission time is used.

It is preferable that radio base stations support a plurality of transmission rates in the radio communication with radio communication terminals, and the transmission at substantially the same frequency indicates that the same transmission rates are selected from the transmission rates.

A computer program for a radio communication system according to a fifth aspect of the present embodiments is used for a radio communication system in which a plurality of base stations is connected, and the radio base stations and radio communication terminal are capable of communicating with each other by radio. The program causes a computer to perform frequency reception processing for receiving frequency information on a first radio base station from the first radio base station, collision judgment processing for judging whether a second radio base station and the first radio base station perform transmission at substantially a same frequency based on the frequency information, and power adjustment processing for lowering, when it is judged that substantially the same frequency is used, transmission power between the second radio base station and a radio communication terminal to predetermined power, with which communication between the second radio base station and the radio communication terminal is still maintained, and lowering transmission power for performing radio communication between the first radio base station and a radio communication terminal to predetermined power, with which communication between the first radio base station and the radio communication terminal is still maintained.

It is preferable that communication ranges of the first and second base station overlaps.

It is preferable that, in the power adjustment processing, transmission power of radio base stations and radio communication terminals is adjusted.

It is preferable that, in the power adjustment processing, the radio base stations lower transmission power to predetermined power and notify the radio communication terminal of the predetermined power, and the radio communication terminal, receiving the notification, lowers transmission power to the power notified.

It is preferable that the radio communication between radio base stations and radio communication terminals is half duplex radio communication, and the program causes a computer to further perform timing judgment processing for judging whether overlap of transmission timing occurs, and, when it is judged in the timing judgment processing that the overlap occurs, adjustment in the power adjustment processing is performed.

It is preferable that the radio communication between radio base stations and radio communication terminals is sectioned into units of transmission time and overlap of the transmission timing indicates that the same unit of transmission time is used.

It is preferable that the radio base stations support a plurality of transmission rates in the radio communication with radio communication terminals, and the transmission at substantially the same frequency indicates that the same transmission rates are selected from the transmission rates.

As described above, according to the present embodiments, it is possible to reduce occurrence of collision of frame transmission timing even in a period in which control for allocating a transmission right from a radio communication system to respective radio communication terminals is not performed, increase a maximum number of simultaneous connections within a communication capacity range of a communication frequency set in advance, shorten a waiting time in radio communication, and increase speed of communication without causing an increase in cost for addition of radio base stations, replacement with a high-performance model, and the like.

Consequently, in the case of data communication, it is possible to improve transmission speed of data and, in the case of voice communication, it is possible to increase the number of simultaneous calls.

### BRIEF DESCRIPTION OF THE DRAWINGS

The objects and features of the present invention will become more apparent from the consideration of the following detailed description taken in conjunction with the accompanying drawings, in which:

FIG. 1 is a diagram showing an example of a structure of a radio communication system 100 according to an embodiment of the present invention;

FIG. 2 is a diagram showing an example of a structure of a radio base station 2 according to the embodiment;

FIG. 3 is a diagram showing an example of a structure of a radio communication terminal 3 according to the embodiment;

FIG. 4 is a flowchart showing a communication connecting operation by the radio base station 2; and

FIG. 5 is a diagram schematically showing a transmission frame in the radio communication system 100.

### DESCRIPTION OF THE EXEMPLARY EMBODIMENTS

An exemplary embodiment is described of a radio communication system, a radio base station, a radio communication terminal, a radio communication method, and a program for the radio communication system that are applied to a radio communication system that performs sound communication with a VoIP application in a wireless LAN (Local Area Network).

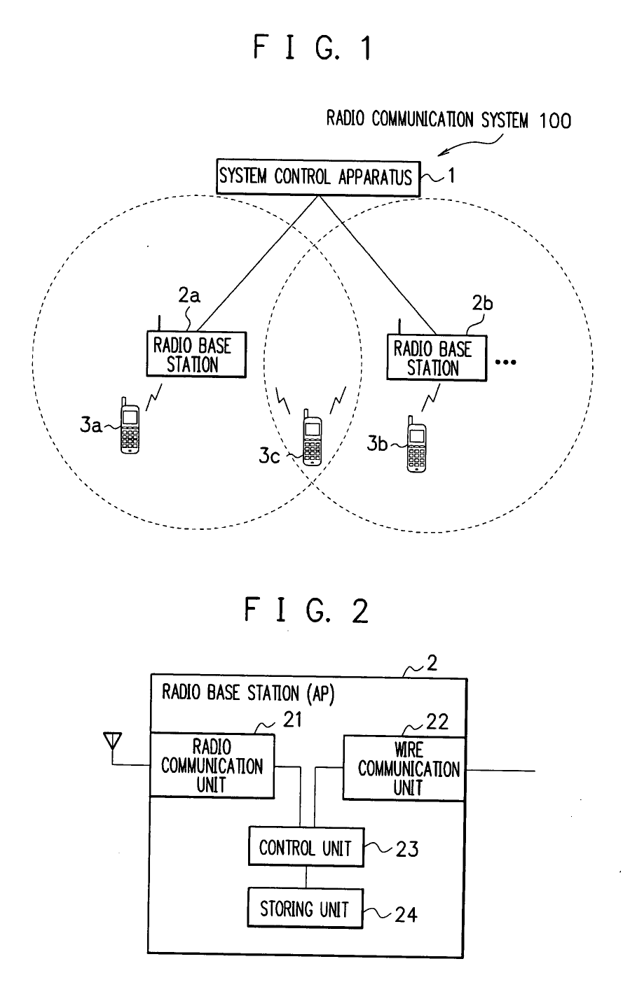

In a radio communication system 100, as shown in FIG. 1, radio base stations 2 (2a, 2b, . . . ) (APs: Access Points) are connected to a system control device 1 (controller), and the radio base stations 2 and radio communication terminals 3 are capable of communicating with each other by radio.

The system control device 1 performs various kinds of control in radio communication through the radio base stations 2 such as handover between the radio base stations 2, and controls communication in the radio communication system 100.

Each of the radio base stations 2 includes, as shown in FIG. 2, a radio communication unit 21 that performs radio communication with the radio communication terminal 3 and the like, a wire communication unit 22 that performs communication through wire with the system control device 1 and the like, a control unit 23 that controls the entire radio base station 2, and a storing unit 24.

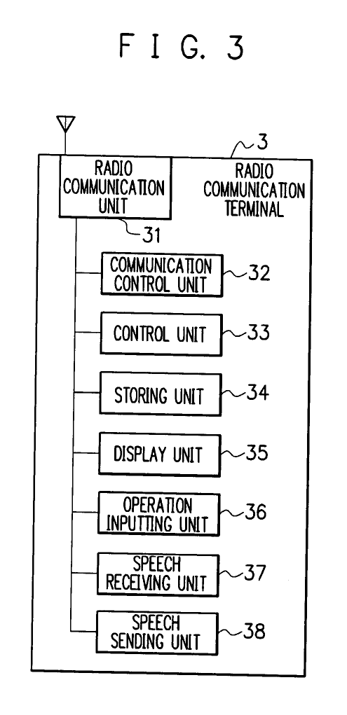

The radio communication terminal 3 includes, as shown in FIG. 3, a radio communication unit 31 that performs radio communication with the radio base station 2 and the like, a communication control unit 32 that controls transmission power, for example, of the radio communication unit 31, a control unit 33 that controls the entire radio communication terminal 3, a storing unit 34, a display unit 35 that displays various kinds of information, an operation inputting unit 36 that receives an input from a user, and a speech receiving unit 37 and a speech sending unit 38 that perform voice communication.

The radio communication system 100 performs so-called “multi-rate” communication that supports a plurality of transmission rates in radio communication between the radio base station 2 and the radio communication terminal 3.

For example, the IEEE802.11b standard defines four transmission rates of 11, 5.5, 2, and 1 Mbps. The IEEE802.11a standard defines eight transmission rates of 54, 48, 36, 24, 18, 12, 9, and 6 Mbps (54, 48, 36, 18, and 9 Mbps are options).

The radio communication system 100 restricts the start time of transmission frames, and divides data transmission into a predetermined minimum time unit (slot): “slotting” is performed.

Data communication over each communication frequency is slotted. As a result, frame transmission is performed to synchronize with slot start time and the length of a frame to be transmitted is set to be the same as the length of a slot.

Consequently, even in communication using one communication frequency, it is possible to simultaneously perform radio communication between a radio base station and a plurality of terminals.

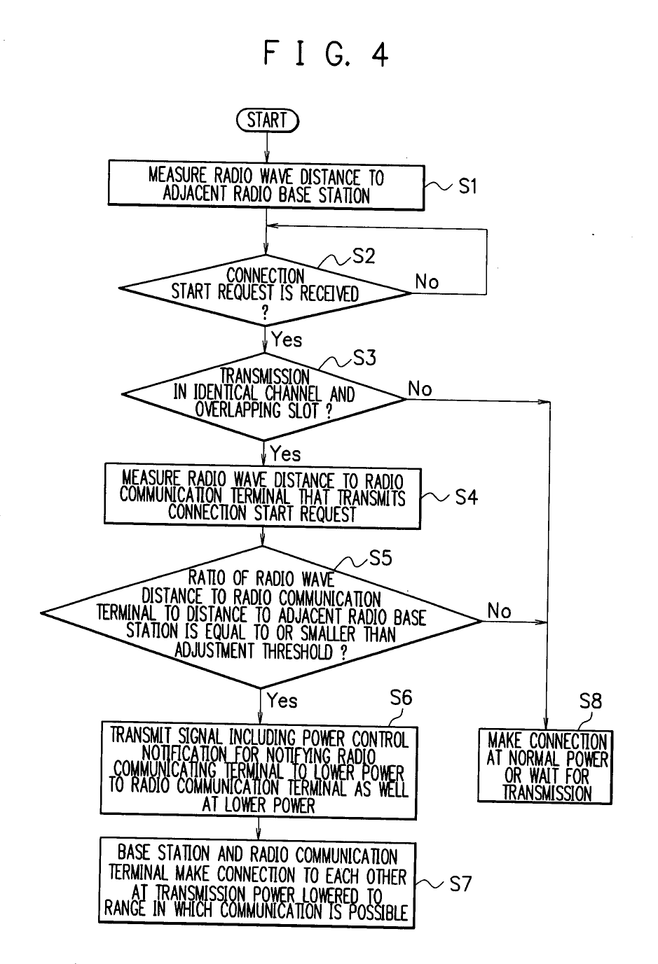

A communication connecting operation in the radio communication system 100 will be explained with reference to a flowchart in FIG. 4 using an operation of the radio base station 2a as an example.

First, the radio base station 2a receives neighbor information from another radio base station 2b adjacent to the radio base station 2a and acquires transmission power information included in the neighbor information, and information on a time frame for communication with the radio communication terminal 3. At the same time, the radio base station 2a measures radio field intensity of the neighbor information to calculate a free space loss from information of the transmission power, and calculate a radio wave distance with the transmission power information acting as a parameter (step S1).

In other words, the radio wave distance in this specification means a distance derived from the free space loss involved in the transmission with the transmission power information acting as a parameter.

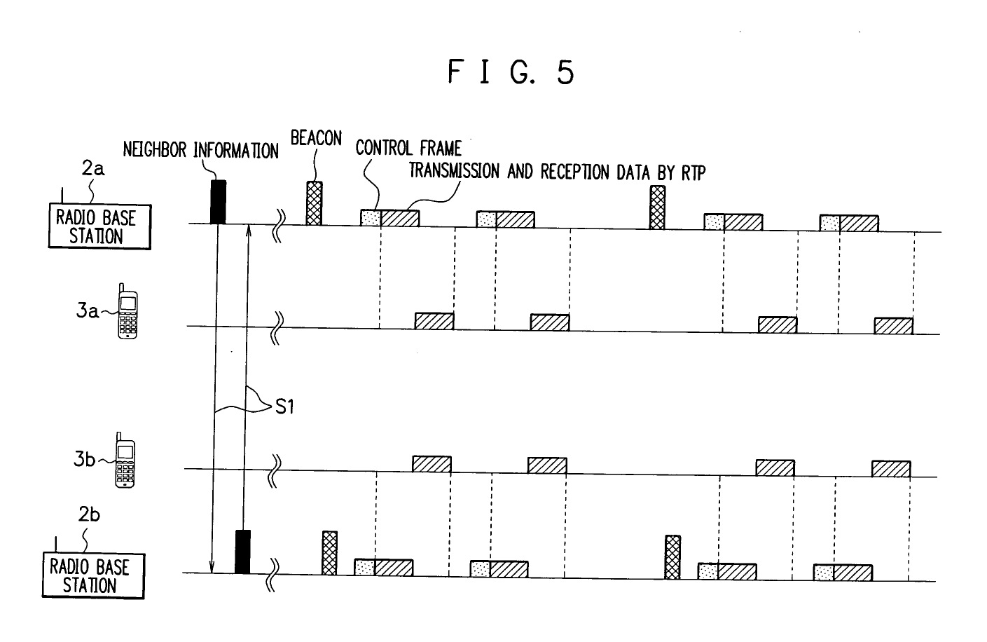

As shown in FIG. 5, the neighbor information is transmitted periodically at timing set in advance. The timing is different from beacon (broadcasting information) transmitted for periodical exchange of information among the radio base stations 2. The neighbor information is also used, among the radio base stations 2, for exchange of information not included in the beacon.

The radio base station 2a receives a connection start request from the radio communication terminal 3a (step S2). The base station 2a judges, from a communication state (a traffic state) between the radio base station 2a and other radio communication terminals 3 at that point, whether a transmission frame used for connection with the radio communication terminal 3a has to be transmitted at a communication frequency identical with a communication frequency (a channel) used in radio communication in the radio base station 2b adjacent to the radio base station 2a, and has to be transmitted using a slot overlapping the slot the radio base station 2b uses.

If based on a margin in the traffic of the radio base station 2a, it is possible to transmit transmission frames at a communication frequency different from the communication frequency the radio base station 2b uses, or it is possible to transmit transmission frames using a slot not overlapping the slot the radio base station 2b uses (step S3, No), the radio base station 2a causes the radio communication terminal 3a to make connection to the radio base station 2a at normal transmission power using an available communication frequency and slot (step S8).

If there is no choice but to use the same communication frequency as the radio base station 2b uses, and an overlapping slot with the radio base station 2b to establish communication with the radio communication terminal 3 (step S3: Yes) (for example, when many radio base stations 2 performs radio communication using an identical communication frequency), the radio base station 2a acquires transmission power information included in the connection start request signal sent from the radio communication terminal 3a. The radio base station 2a calculates a free space loss as described above from the transmission power information and field intensity at the time of reception of the connection start request and calculates a radio wave distance using the transmission power information as a parameter (step S4).

When a ratio of the radio wave distance to the radio communication terminal 3a calculated in this way to a physical distance to the radio base station 2b is equal to or smaller than an adjustment threshold set in advance (step S5: Yes), the radio base station 2a transmits a signal including power control notification for requesting the radio communication terminal 3a to lower transmission power to predetermined power with which communication is possible, to the radio communication terminal 3a at the transmission power lowered to the predetermined power (step S6).

The “transmission power with which communication is possible”, i.e., a controlled power value with the transmission power lowered, is calculated by the control unit 23 of the radio base station 2a. The controlled power value is kept as small as possible so that communication is established as far as the radio wave distance calculated in step S4.

In this way, the radio base station 2 transmits the power control notification to the radio communication terminal 3a. After both the radio base station 2a and the radio communication terminal 3a prepare for performing radio communication at the transmission power of the controlled power value calculated as described above, the radio base station 2a causes the radio communication terminal 3a to establish connection (step S7). As shown in FIG. 5, the radio base station 2a starts packet transmission according to an RTP (Real-time Transport Protocol).

When a ratio of the radio wave distance to the radio communication terminal 3a calculated in this way to a physical distance to the radio base station 2b is larger than an adjustment threshold set in advance (step S5, No), the radio base station 2a establishes connection at the normal transmission power and starts packet transmission after a slot for transmission becomes available.

As described above, in the radio communication system according to this embodiment, even when it is possible to connect the radio communication terminal 3 only at a communication frequency identical with the communication frequency used in radio communication in the radio base station 2b adjacent to the radio base station 2a and using a slot overlapping the slot used in the radio base station 2b, for example, when there are a large number of radio base stations 2 that perform radio communication using an identical communication frequency, both the radio base station 2a and the radio communication terminal 3a lower transmission power to the predetermined value, with which communication is still established. This makes it possible to allow radio communications at the same communication frequency and through the overlapping slots to coexist and increase the number of simultaneous connections.

Therefore, it is possible to reduce occurrence of collision of frame transmission timing, increase a maximum number of simultaneous connections within a communication capacity range of a communication frequency set in advance, shorten a waiting time in radio communication, and increase a maximum number of simultaneous calls without causing an increase in cost for addition of radio base stations, replacement with a high-performance model, and the like.

When a ratio of a radio wave distance between the radio base station 2a and the radio communication terminal 3a to a physical distance between the radio base station 2a and the radio base station 2b adjacent to the radio base station 2a is equal to or smaller than the adjustment threshold set in advance, the processing for lowering transmission power to a predetermined value (communication can still be established) is performed. This makes it possible to surely bring out the effect of adjustment of transmission power and increase the number of simultaneous connections while a stable communication quality is maintained.

Frame collision among the radio base stations 2 that use an identical channel is prevented as described above. Thus, it is possible to prevent frame collision and use a channel efficiently even during the CP in which the DCF prescribed in the IEEE802.11 wireless LAN functions, like during the CFP in which the PCF functions. This makes it possible to increase speed of communication and increase a maximum number of calls at the time when an identical channel is used.

The embodiment described above is an exemplary embodiment. The present invention is not limited to the embodiment. It is possible to modify the present invention in various ways on the basis of the technical idea of the present invention and carry out the present invention.

The embodiment was applied to a radio communication system that performs voice communication using VoIP applications. However, the present invention is not limited to this embodiment. It is also possible to apply the present invention to a wireless communication system that does not use an RTP such as a wireless LAN that performs only data communication.

Even when the present invention is applied to such various wireless LANs, it is possible to increase speed of communication by increasing a maximum number of simultaneous connections and reducing a waiting time in radio communication.

In the explanation of the embodiment, the system control device 1 and the radio base stations 2 communicate by wire. However, a form of communication is not limited to this as long as communication is possible. Wireless communication may be used.

The means and the functions of the radio base stations 2 according to the embodiment may be realized over the radio communication system 100. For example, a system control device may have the means and the functions, or the means and the functions may be realized by cooperative work between the system control device and radio base stations.

In the explanation of the embodiment, the radio base stations are connected to one system control device. However, the radio communication system is not limited to such a configuration as long as it is possible to perform communication among plural radio base stations. It is also possible to apply the present invention to a radio communication system in which a plurality of system control devices is connected, and radio base stations are connected to the respective system control devices.

When the processing procedure for realizing the radio communication system is recorded in a recording medium as a program, it is possible to realize the functions according to the embodiment by causing a CPU of a computer constituting the system to perform the processing according to the program supplied from the recording medium.

A group of information items including programs may be supplied from a recording medium or supplied from an external recording medium via a network.

In other words, a program code itself read out from a recording medium realizes new functions of the present invention. A recording medium storing a program code, and signals read out from the recording medium constitute the present invention.

As the recording medium, for example, a floppy® disk, a hard disk, an optical disk, a magneto-optical disk, a CD-ROM, a CD-R, a magnetic tape, a nonvolatile memory card, a ROM, and an EEPROM may be used.

In the program according to the present invention, it is possible to cause a radio communication system and a radio base station controlled by the program to realize the functions in the radio communication system according to the embodiment.

While the invention has been described in terms of several exemplary embodiments, those skilled in the art will recognize that the invention can be practiced with modification within the spirit and scope of the appended claims.

Further, it is noted that Applicant's intent is to encompass equivalents of all claim elements, even if amended later during prosecution.

What is claimed is:

1. A radio communication system in which a plurality of radio base stations is connected to a system control device, and the radio base stations and radio communication terminals are capable of communicating with each other by radio, the radio communication system comprising
a power adjusting means for lowering a transmission power for performing radio communication between a first radio base station and a first radio communication terminal to a first predetermined power, with which communication is still maintained, and lowering a transmission power for performing radio communication between a second radio base station and a second radio communication terminal to a second predetermined power, with which communication is still maintained, while the first radio base station and the second radio base station communicate at substantially a same frequency.

2. The radio communication system according to claim 1, wherein communication ranges of the first and second radio base stations overlap.

3. The radio communication system according to claim 1, wherein
each of the radio base stations includes a radio transmission and reception section for transmitting and receiving signals by radio communication, and
when the radio transmission and reception section of a first radio base station receives, from a second radio base station, a notification indicating that the second radio base station performs a transmission at substantially the same frequency with a frequency that the first radio base station intends to use or is using, the first radio base station recognizes that the second radio base station performs transmission substantially at the same frequency.

4. The radio communication system according to claim 1, wherein the power adjusting means includes:
a base-station-side power adjusting section that adjusts the transmission power of radio base stations, and
a terminal-side power adjusting section that adjusts the transmission power of radio communication terminals.

5. The radio communication system according to claim 4, wherein
each of the radio base stations includes a power-adjustment notifying section that requests a radio communication terminal to lower the transmission power to the predetermined power, and
when the base-station-side power adjusting section of a radio base station lowers the transmission power to the predetermined power, the power-adjustment notifying section notifies a radio communication terminal of the predetermined power, and the terminal-side-power adjusting section of a radio communication terminal, receiving the notification, lowers its transmission power to the predetermined power.

6. The radio communication system according to claim 1, wherein radio communication between radio base stations and radio communication terminals comprises a half duplex radio communication, and
when overlap occurs in transmission timing, the power adjusting means lowers transmission power to the predetermined power.

7. The radio communication system according to claim 6, wherein
radio communication between radio base stations and radio communication terminal is sectioned into units of transmission time, and
an overlap in the transmission timing indicates that the same unit of transmission time is used.

8. The radio communication system according to claim 1, wherein
radio base stations support a plurality of transmission rates in the radio communication with radio communication terminals, and
transmission at substantially the same frequency indicates that the same transmission rates are selected from the transmission rates.

9. A radio base station that communicates with a radio communication terminal by radio, comprising:
a base-station-side power adjusting section that lowers, when another radio base station performs transmission at substantially a same frequency, a transmission power for performing radio communication with a radio communication terminal to a predetermined power, with which communication is still maintained; and
a power-adjustment notifying section that requests the radio communication terminal to lower its transmission power to the predetermined power, with which communication is still maintained.

10. The radio base station according to claim 9, wherein communication ranges of the radio base station and another radio base station overlap.

11. The radio base station according to claim 9, further comprising a radio transmission and reception section that transmits and receives signals by radio communication, wherein
when the radio transmission and reception section receives, from another radio base station, a notification indicating that another radio base station performs transmission at substantially the same frequency with a frequency that the radio base station intends to use or is using, the radio base station recognizes that another radio base station performs transmission at the substantially same frequency.

12. The radio base station according to claim 9, wherein
the radio communication between the radio base station and a radio communication terminal comprises a half duplex radio communication, and
when overlap occurs in transmission timing, the base-station-side power adjusting section lowers its transmission power to the predetermined power.

13. The radio base station according to claim 12, wherein
the radio communication between the radio base station and a radio communication terminal is sectioned into units of transmission time, and
an overlap in the transmission timing indicates that a same unit of transmission time is used.

14. The radio base station according to claim 9, wherein the radio base station supports a plurality of transmission rates in the radio communication with radio communication terminals, and
transmission at substantially a same frequency indicates that the same transmission rates are selected from the transmission rates.

15. A radio communication terminal comprising:
a radio transmission and reception section that transmits and receives signals by radio communication; and
a terminal-side-power adjusting section that lowers, when the radio transmission and reception section receives, from a radio base station, a notification for lowering transmission power to a predetermined power, with which communication is still maintained, its transmission power to the predetermined power.

16. A radio communication method for a radio communication system in which a plurality of radio base stations is connected, and the radio base stations and radio communication terminals are capable of communicating with each other by radio, the radio communication method comprising:
a frequency receiving step of receiving frequency information on a first radio base station from the first radio base station;
a collision judging step of judging whether a second radio base station and the first radio base station perform transmission at substantially a same frequency based on the frequency information; and
a power adjusting step of lowering, when it is judged that substantially the same communication frequency is used, transmission power between the second radio base station and a radio communication terminal to a predetermined power, with which communication between the second radio base station and the radio communication terminal is still maintained, and lowering a transmission power between the first radio base station and a radio communication terminal to the predetermined power, with which communication between the first radio base station and the radio communication terminal is still maintained.

17. The radio communication method according to claim 16, wherein communication ranges of the first and second base stations overlap.

18. The radio communication method according to claim 16, wherein, in the power adjusting step, transmission power of radio base stations and radio communication terminals is adjusted.

19. The radio communication method according to claim 16, wherein, in the power adjusting step, the radio base stations lower their transmission power to the predetermined power and notify the radio communication terminal of the predetermined power, and the radio communication terminal, receiving the notification, lowers its transmission power to the power notified.

20. The radio communication method according to claim 16, wherein
radio communication between radio base stations and radio communication terminals comprises a half duplex radio communication, and
the method further includes a timing judging step of judging whether an overlap of transmission timing occurs, and
when it is judged in the timing judging step that the overlap occurs, adjustment in the power adjusting step is performed.

21. The radio communication method according to claim 20, wherein
radio communication between radio base stations and radio communication terminals is sectioned into units of transmission time, and
the overlap of transmission timing indicates that a same unit of transmission time is used.

22. The radio communication method according to claim 16, wherein
radio base stations support a plurality of transmission rates in the radio communication with radio communication terminals, and
transmission at substantially the same communication frequency indicates that the same transmission rates are selected from the transmission rates.

23. A computer program of machine-readable instructions tangibly embedded in a medium for a radio communication system in which a plurality of radio base stations is connected, and the radio base stations and radio communication terminals are capable of communicating with each other by radio, causing a computer to perform:
frequency reception processing for receiving frequency information on a first radio base station from a first radio base station;
collision judgment processing for judging whether a second radio base station and the first radio base station perform transmission at substantially a same communication frequency based on the frequency information; and
power adjustment processing for lowering, when it is judged that substantially the same frequency is used, a transmission power between the second radio base station and a radio communication terminal to a predetermined power, with which communication between the second radio base station and the radio communication terminal is still maintained, and lowering a transmission power for performing radio communication between the first radio base station and a radio communication terminal to a predetermined power, with which communication between the first radio base station and the radio communication terminal is still maintained.

24. The computer program according to claim 23, wherein communication ranges of the first and the second base station overlaps.

25. The computer program according to claim 23, wherein, in the power adjustment processing, the transmission power of radio base stations and radio communication terminals is adjusted.

26. The computer program according to claim 23, wherein, in the power adjustment processing, the radio base stations lower their transmission power to the predetermined power and notify the radio communication terminal of the predetermined power, and the radio communication terminal, receiving the notification, lowers its transmission power to the power notified.

27. The computer program according to claim 23, wherein
radio communication between radio base stations and radio communication terminals comprises a half duplex radio communication, and
the computer program causes a computer to further perform timing judgment processing for judging whether an overlap of transmission timing occurs, and
when it is judged in the timing judgment processing that the overlap occurs, adjustment in the power adjustment processing is performed.

28. The computer program according to claim 27, wherein
radio communication between radio base stations and radio communication terminals is sectioned into units of transmission time, and
the overlap of transmission timing indicates that a same unit of transmission time is used.

29. The computer program according to claim 23, wherein
radio base stations support a plurality of transmission rates in the radio communication with radio communication terminals, and
transmission at substantially the same communication frequency indicates that same transmission rates are selected from the transmission rates.
